(19) United States
(12) Patent Application Publication
(10) Pub. No.: US 2026/0161150 A1
(43) Pub. Date: Jun. 11, 2026

(54) TRAJECTORY GENERATION METHOD AND DEVICE FOR ADDITIVE MANUFACTURING

(71) Applicant: China Academy of Machinery Wuhan Research Institute of Materials Protection Co.,Ltd, Wuhan (CN)

(72) Inventors: Dan Jia, Wuhan (CN); Xiaoshuang Luo, Wuhan (CN); Tian Yang, Wuhan (CN); Lixin Ma, Wuhan (CN); Haitao Duan, Wuhan (CN); Wenxuan Li, Wuhan (CN); Shengpeng Zhan, Wuhan (CN)

(21) Appl. No.: 19/407,030

(22) Filed: Dec. 3, 2025

(30) Foreign Application Priority Data
Dec. 5, 2024 (CN) 2024117792251

(51) Int. Cl. G05B 19/4099; B29C 64/386; B33Y 50/00

(52) U.S. Cl. CPC G05B 19/4099; B29C 64/386; B33Y 50/00; G05B 2219/49023

(57) ABSTRACT

A trajectory generation method and device for additive manufacturing are provided. The trajectory generation method includes: slicing a to-be-printed model to obtain layers of the to-be-printed model, and determining filling lines for a cross-section of each of the layers; determining coordinates and directions of multiple path points on each of the filling lines based on angle division results between a normal vector of a start point of the filling line and a Z-axis direction of a robot coordinate system and between a normal vector of an end point of the filling line and the Z-axis direction of the robot coordinate system; and determining a printing trajectory of a robot based on the coordinates and directions of the multiple path points. The trajectory generation method makes motion trajectories of industrial robots smoother and printing speeds of the industrial robots uniform and consistent.

### CROSS-REFERENCE TO RELATED APPLICATION

This application claims priority to Chinese Patent Application No. 202411779225.1, filed on Dec. 5, 2024, which is herein incorporated by reference in its entirety.

### TECHNICAL FIELD

The disclosure relates to the technical field of additive manufacturing, and more particularly to a trajectory generation method and device for additive manufacturing.

### BACKGROUND

Currently, in printing equipment with three or four degrees of freedom, due to a lack of rotational freedom, mobile devices carrying laser heads or print heads cannot achieve support-free printing during printing process, which to some extent limits geometric shapes of printed objects and printing efficiency.

Using industrial robots carrying laser cladding heads for three-dimensional printing through powder or wire feeding is currently a widely used additive manufacturing process, which has characteristics of fast printing speed and ability to manufacture workpieces with large sizes.

However, due to acceleration and deceleration movements of the industrial robots, excessive material deposition occurs in low-speed areas, resulting in printing defects.

### SUMMARY

The disclosure provides a trajectory generation method and device for additive manufacturing to address a defect of excessive material deposition in low-speed areas due to acceleration and deceleration movements of industrial robots in the art, thereby achieving a trajectory generation method for the additive manufacturing with a more uniform printing speed.

The trajectory generation method for the additive manufacturing provided by the disclosure includes the following steps:
slicing a to-be-printed model to obtain layers of the to-be-printed model, and determining filling lines for a cross-section of each of the layers of the to-be-printed model;
determining coordinates and directions of multiple path points on each of the filling lines based on angle division results between a normal vector of a start point of the filling line and a Z-axis direction of a robot coordinate system and between a normal vector of an end point of the filling line and the Z-axis direction of the robot coordinate system; and
determining a printing trajectory of a robot based on the coordinates and directions of the multiple path points.

According to the trajectory generation method for the additive manufacturing provided by the disclosure, the slicing a to-be-printed model to obtain layers of the to-be-printed model, and determining filling lines for a cross-section of each of the layers of the to-be-printed model specifically comprises the following steps:
slicing the to-be-printed model along the Z-axis direction of the robot coordinate system, and determining a contour curve of the cross-section of each of the layers obtained by slicing;
determining a minimum bounding box of the contour curve of the cross-section of each of the layers, and generating a set of printing auxiliary lines for the minimum bounding box based on a predetermined offset distance; and
performing intersection Boolean operation between the contour curve of the cross-section of each of the layers and the set of printing auxiliary lines to obtain the filling lines for the cross-section of each of the layers.

According to the trajectory generation method for the additive manufacturing provided by the disclosure, the determining coordinates and directions of multiple path points on each of the filling lines based on angle division results between a normal vector of a start point of the filling line and a Z-axis direction of a robot coordinate system and between a normal vector of an end point of the filling line and the Z-axis direction of the robot coordinate system specifically includes the following steps:
generating a sequence of filling paths for the filling lines of the cross-section of each of the layers, and determining a normal vector of a start point of each of filling paths in the sequence of filling lines and a normal vector of an end point of each of the filling paths in the sequence of filling paths;
determining deviation angles between the normal vector of the start point of each of the filling paths in the sequence of filling lines and the Z-axis direction of the robot coordinate system and between the normal vector of the end point of each of the filling paths in the sequence of filling lines and the Z-axis direction of the robot coordinate system; and dividing the deviation angles based on the deviation angles and preset path point numbers to obtain the angle division results of the deviation angles; and
determining the coordinates and directions of the multiple path points based on the angle division results of the deviation angles.

According to the trajectory generation method for the additive manufacturing provided by the disclosure, the generating a sequence of filling paths for the filling lines of the cross-section of each of the layers specifically includes:
generating the sequence of filling paths for the filling lines of the cross-section of each of the layers by using a zigzag topology.

According to the trajectory generation method for the additive manufacturing provided by the disclosure, the dividing the deviation angles based on the deviation angles and preset path point numbers to obtain the angle division results of the deviation angles, specifically includes:
determining a first positioning point on each of the filling paths, where a normal vector of the first positioning point is parallel to the Z-axis direction of the robot coordinate system and the first positioning point is closest to the start point of the filling path compared with other points on the filling path except the start point; and determining a second positioning point on the filling path, where a normal vector of the second positioning point is parallel to the Z-axis direction of the robot coordinate system and the second positioning point is closest to the end point of the filling path compared with other points on the filling path except the end point;
evenly dividing a first included angle between the normal vector of the start point of the filling path and the normal vector of the first positioning point according to a preset path point number for the first included angle of the preset path point numbers, and evenly dividing a second included angle between the normal vector of the end point of the filling path and the normal vector of the second positioning point according to a preset path point number for the second included angle of the preset path point numbers; and
determining intersection points between angle bisectors evenly dividing the first included angle and the second included angle and the filling path as the multiple path points.

According to the trajectory generation method for the additive manufacturing provided by the disclosure, before dividing the deviation angles based on the deviation angles and the preset path point numbers, the trajectory generation method further includes:
determining a first path length between the start point of the filling path and the first positioning point; and determining a second path length between the end point of the filling path and the second positioning point;
determining the first path length and the second path length as path lengths to be evenly divided; and
taking integers of ratios of the path lengths to be evenly divided to a melting speed of the robot as the preset path point number for the first included angle and the preset path point number for the second included angle.

The disclosure further provides a trajectory generation device for the additive manufacturing, including:
a line determination module, configured to slice the to-be-printed model to obtain the layers of the to-be-printed model, and determine the filling lines for the cross-section of each of the layers of the to-be-printed model;
a path point determination module, configured to determine the coordinates and directions of the multiple path points on each of the filling lines based on the angle division results between the normal vector of the start point of the filling line and the Z-axis direction of the robot coordinate system and between the normal vector of the end point of the filling line and the Z-axis direction of the robot coordinate system; and
a trajectory generation module, configured to determine the printing trajectory of the robot based on the coordinates and directions of the multiple path points.

In an embodiment, the line determination module, the path point determination module, and the trajectory generation module are embodied by at least one memory and at least one processor coupled to the at least one memory, and the at least one memory is stored with computer programs executable by the at least one processor.

The disclosure further provides an electronic device, including a memory, a processor, and a computer program stored on the memory and executable on the processor. The processor is configured to execute the computer program to implement the trajectory generation method for the additive manufacturing as described above.

The disclosure still provides a non-transitory computer-readable storage medium. A computer program is stored in the non-transitory computer-readable storage medium, and the computer program is configured to, when executed by a processor, implement the trajectory generation method for the additive manufacturing as described above.

The disclosure still further provides a computer program product, including a computer program. The computer program is configured to, when executed by a processor, implement the trajectory generation method for the additive manufacturing as described above.

The trajectory generation method and device provided by the disclosure, through optimization of the printing trajectory of the robot at starting and ending positions of each of the layers to be printed of the to-be-printed model, path point interpolation, and posture optimization, makes a movement trajectory of an industrial robot smoother and a printing speed of the industrial robot uniform and avoids a phenomenon of excessive deposition in local areas.

### BRIEF DESCRIPTION OF DRAWINGS

In order to more clearly illustrate technical solutions of the disclosure or the related art, a brief introduction will be given to attached drawings required for description of embodiments or the related art. Apparently, the attached drawings described below are part of the embodiments of the disclosure. For those skilled in the art, other attached drawings can be obtained based on these attached drawings without creative labor.

FIG. 1 illustrates a first flowchart of a trajectory generation method for additive manufacturing according to an embodiment of the disclosure.

FIG. 2 illustrates a schematic diagram of a minimum bounding box in the trajectory generation method for the additive manufacturing according to the embodiment of the disclosure.

FIG. 3 illustrates a schematic diagram of printing auxiliary lines in the trajectory generation method for the additive manufacturing according to the embodiment of the disclosure.

FIG. 4 illustrates a schematic diagram of filling lines in the trajectory generation method for the additive manufacturing according to the embodiment of the disclosure.

FIG. 5 illustrates a schematic diagram of angle equalization in the trajectory generation method for the additive manufacturing according to the embodiment of the disclosure.

FIG. 6 illustrates a second flowchart of the trajectory generation method for the additive manufacturing according to the embodiment of the disclosure.

FIG. 7 illustrates a schematic structural diagram of a trajectory generation device for the additive manufacturing according to the embodiment of the disclosure.

FIG. 8 illustrates a schematic structural diagram of an electron device according to the embodiment of the disclosure.

### DETAILED DESCRIPTION OF EMBODIMENTS

To make purposes, technical solutions, and advantages of the disclosure clearer, the technical solutions of the disclosure will be described clearly and completely with reference to attached drawings of the disclosure. Apparently, embodiments described below are a part of embodiments of the disclosure, not all of them. Based on the embodiments of the disclosure, all other embodiments obtained by those skilled in the art without creative labor shall fall within a scope of protection of the disclosure.

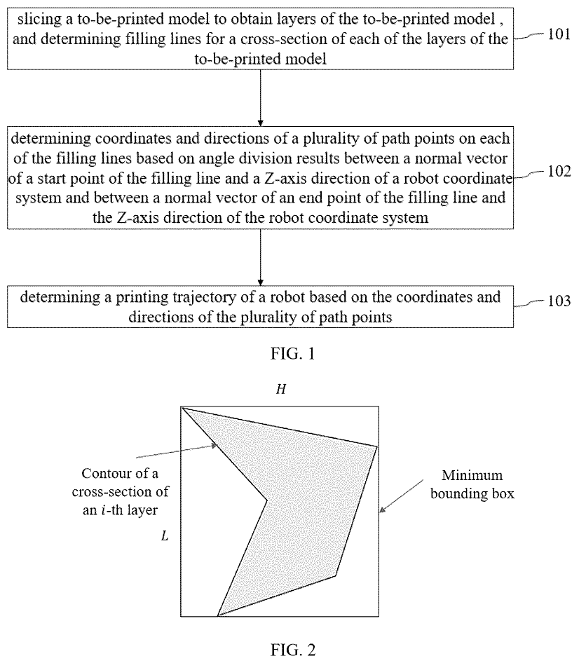

A trajectory generation method for additive manufacturing will be illustrated with reference to FIG. 1 through FIG. 6. As illustrated in FIG. 1, the trajectory generation method includes the following step 101 through step 103.

Step 101, a to-be-printed model is sliced to obtain layers of the to-be-printed model. Filling lines for a cross-section of each of the layers of the to-be-printed model are determined.

Optionally, the to-be-printed model is sliced along a fixed direction, and the fixed direction can be determined according to a shape of the to-be-printed model, as long as the cross-section of each of the layers of the to-be-printed model can be easily printed after slicing the to-be-printed model.

Optionally, the to-be-printed model can be evenly sliced, or the to-be-printed model can be unevenly sliced according to the shape of the to-be-printed model.

After slicing the to-be-printed model, a shape of the cross-section of each of the layers of the to-be-printed model is determined, and then the filling lines for the cross-section of each of the layers is determined as a basis for filling paths based on the shape of the cross-section.

Step 102, coordinates and directions of multiple path points on each of the filling lines are determined based on angle division results between a normal vector of a start point of the filling line and a Z-axis direction of a robot coordinate system and between a normal vector of an end point of the filling line and the Z-axis direction of the robot coordinate system.

It should be noted that, during the additive manufacturing, when a robot prints a flat surface, a laser print head moves directly along straight paths, so a printing speed of the robot is faster. However, when the robot prints inclined or curved surfaces that are not perpendicular to the Z-axis direction of the robot coordinate system, an orientation of the laser print head must be adjusted to align with a normal vector of each path point to be printed. When an adjustment amplitude is large, the printing speed of the robot is slower.

For example, when the to-be-printed model is a sphere, after slicing the sphere along its radial direction, an outermost part of a cross-section of each of the layers is a curved surface, and a middle part of the cross-section is a flat part that can be directly printed. Therefore, during printing the outermost part and the middle part, it is prone to local deposition due to uneven printing speed.

Therefore, during a printing process, it is necessary to distinguish the flat part that can be directly printed from other parts that require rotation adjustment of the laser print head and optimize a rotation adjustment trajectory of the laser print head, so as to make an overall printing speed more balanced and reduce an occurrence of a phenomenon of local excessive deposition.

In filling lines determined in a cross-section of the to-be-printed model, to determine an angle between a normal vector of a start point of a certain filling line and the Z-axis direction of the robot coordinate system and an angle between a normal vector of an end point of the certain filling line and the Z-axis direction of the robot coordinate system is to determine areas in the certain filling line where a trajectory of the laser print head needs to be optimized.

To divide the angle between the normal vector of the start point of the certain filling line and the Z-axis direction of the robot coordinate system and the angle between the normal vector of the end point of the certain filling line and the Z-axis direction of the robot coordinate system is to divide an angle that needs to be adjusted when the laser print head moves once into multiple smaller angles, so as to facilitate movement of the laser print head and improve a moving speed of the laser print head during printing the areas where the trajectory of the laser print head needs to be optimized.

On this basis, it should be understood that optimization of the trajectory of the laser print head is carried out from an aspect of optimizing a rotational angle of the laser print head. A result of angle adjustment still needs to be converted into a printing trajectory, namely, the coordinates and directions of the multiple path points on the filling line, so as to finally determine a printing trajectory of the laser print head.

Step 103, a printing trajectory of the robot is determined based on the coordinates and directions of the multiple path points.

The coordinates and directions of the multiple path points ultimately determined are organized into forms of the coordinates and normal vectors of the multiple path points. In the robot coordinate system, namely a working coordinate system of the laser print head, each of the multiple path points and a normal vector thereof are added to a controller of the robot in forms of a three-dimensional coordinate position and quaternion poses q1, q2, q3, and q4, thereby generating a three-dimensional printing trajectory of the laser print head, which is the printing trajectory of the robot. After obtaining the printing trajectory of the robot, the robot is controlled to move along the printing trajectory to print the to-be-printed model.

The disclosure, through optimization of the printing trajectory of the robot at starting and ending positions of each of the layers to be printed of the to-be-printed model, path point interpolation, and posture optimization, makes a movement trajectory of an industrial robot smoother and a printing speed of the industrial robot uniform and avoids the phenomenon of excessive deposition in local areas.

In the trajectory generation method for the additive manufacturing, the step 101 of slicing the to-be-printed model to obtain the layers of the to-be-printed model and determining the filling lines for the cross-section of each of the layers of the to-be-printed model specifically includes the following sub-step 101-1 through sub-step 101-3.

Sub-step 101-1, the to-be-printed model is sliced along the Z-axis direction of the robot coordinate system, and a contour curve of the cross-section of each of the layers obtained by slicing is determined.

Optionally, the to-be-printed model is a STereoLithography (STL) model.

The to-be-printed model is divided equidistantly along a positive direction of a Z axis of the robot coordinate system, which facilitates printing operation of the robot. In other feasible embodiments, slicing can also be performed first, and then a slicing direction can be adjusted to the Z-axis direction of the robot coordinate system; that is, the to-be-printed model is overall rotated, so that after rotation, the slicing direction of the to-be-printed model is parallel to the Z-axis direction of the robot coordinate system.

Further, contour curves of cross-sections of the layers n in quantity are obtained after slicing. On this basis, a filling density p and offset times γ are preset correspondingly according to printing requirements.

Sub-step 101-2, a minimum bounding box of the contour curve of the cross-section of each of the layers is determined; and a set of printing auxiliary lines for the minimum bounding box is generated based on a predetermined offset distance.

As illustrated in FIG. 2, a minimum bounding rectangle of the contour curve of the cross-section of each of the layers is taken as the minimum bounding box of the contour curve of the cross-section of each of the layers. A length and a width of the minimum bounding box are expressed as L and H, respectively.

The predetermined offset distance is predetermined according to a formula expressed as follows: D=L/Y.

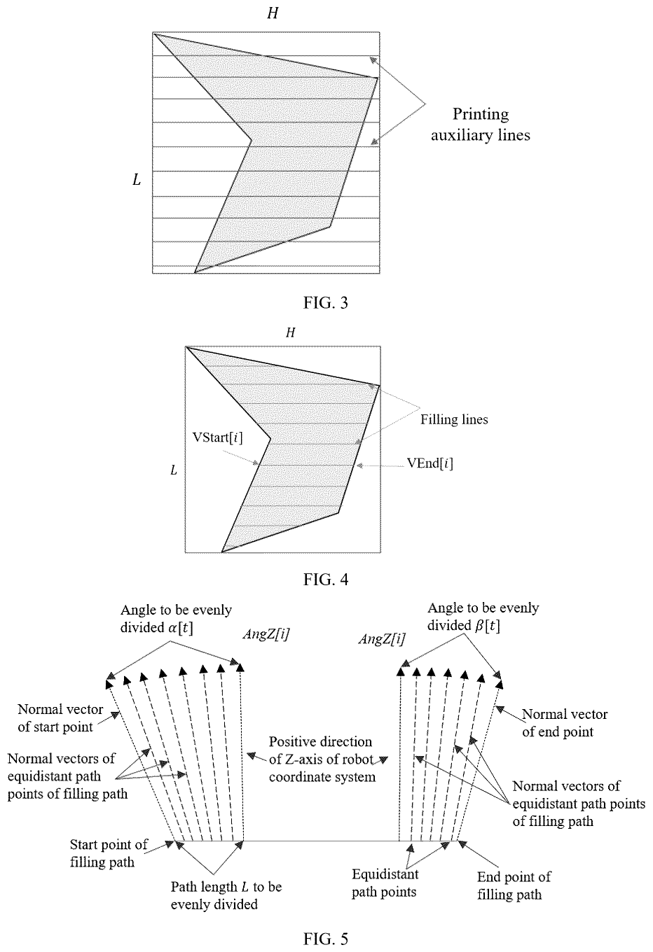

On this basis, the set of printing auxiliary lines for the minimum bounding box is generated from top to bottom with the predetermined offset distance D, as illustrated in FIG. 3.

Sub-step 101-3, an intersection Boolean operation is performed between the contour curve of the cross-section of each of the layers and the set of printing auxiliary lines to obtain the filling lines for the cross-section of each of the layers.

The intersection Boolean operation is performed between a contour curve of a cross-section of an i-th layer and printing auxiliary lines to obtain a set of filling lines inside the contour curve of the cross-section of the i-th layer, as illustrated in FIG. 4.

It should be understood that the filling lines for the cross-section of each of the layers is a set of line segments.

The set of filling lines of the cross-section of the i-th layer is named as array line [γ], where γ is a natural number and γ∈1, 2, . . . , n.

In the trajectory generation method for the additive manufacturing of the disclosure, the step 102 of determining the coordinates and directions of the multiple path points on each of the filling lines based on angle division results between the normal vector of the start point of the filling line and the Z-axis direction of the robot coordinate system and between the normal vector of the end point of the filling line and the Z-axis direction of the robot coordinate system specifically includes the following sub-step 102-1 through sub-step 102-3.

Sub-step 102-1, a sequence of filling paths for the filling lines of the cross-section of each of the layers is generated; and a normal vector of a start point of each of filling paths in the sequence of filling paths and a vector of an end point of each of the filling paths in the sequence of filling paths are determined.

The filling paths are generated correspondingly according to the filling lines for the cross-section of each of the layers and then combined to obtain the sequence of filling paths.

The filling paths are filling lines with directions. Taking the filling lines shown in FIG. 4 as an example, in a feasible embodiment, the filling paths generated for the filling lines are printed in a fixed direction from left to right. In another feasible embodiment, a first line of the filling lines from top to bottom is taken as a first printing line and printed from left to right, and a second line of the filling lines from top to bottom is taken as a second printing line and printed from right to left, thereby making the printing trajectory continuous.

A sequence of filling paths corresponding to the array line [γ] of the cross-section of the i-th layer is generated. A normal vector of a start point and a normal vector of an end point of each of the filling paths in the sequence of filling paths are determined. As illustrated in FIG. 5, the normal vector of the start point and the normal vector of the end point of the filling path are indicated by dotted directional arrows.

Sub-step 102-2, deviation angles between the normal vector of the start point of each of the filling paths in the sequence of filling paths and the Z-axis direction of the robot coordinate system and between the normal vector of the end point of each of the filling paths in the sequence of filling paths and the Z-axis direction of the robot coordinate system are determined. The deviation angles are divided based on the deviation angles and preset path point numbers to obtain the angle division results of the deviation angles.

A deviation angle of each of the filling paths between the normal vector of the start point of the filling path and the Z-axis direction of the robot coordinate system, as illustrated in FIG. 5, refers to an angle required for a dotted directional arrow corresponding to the start point of the filling path to rotate to a dotted directional arrow corresponding to AngZ[i].

Processing of the end point of each of the filling paths is the same as that of the start point, so it will not be repeated herein.

Through this method, a start area and an end area of each of the filling paths where the trajectory of the laser print head needs to be optimized have been determined.

On this basis, a path point number is predetermined. A deviation angle is divided based on the path point number. The path point number is equal to a number of angle bisectors generated after dividing the deviation angle. For example, when the path point number is 4 and the deviation angle is 10 degrees (°), the deviation angle is evenly divided into 5 parts; and each of the 5 parts has a deviation angle of 2°.

Optionally, the path point number is predetermined according to experience.

Sub-step 102-3, the coordinates and directions of the multiple path points are determined based on the angle division results of the deviation angles.

On a basis of angle division, intersection points between angle bisectors obtained by dividing the deviation angles and the filling path are determined as the multiple path points, as illustrated in FIG. 5, dashed directional arrows in FIG. 5 are the angle bisectors obtained by dividing the deviation angles. Intersection points between the dashed directional arrows and the filling path are taken as the multiple path points obtained by dividing the deviation angles. The intersection points are taken as supplementary path points on a basis of the start point and the end point of the filling path.

Coordinates and directions of the supplementary path points are determined and then converted into the trajectory of the laser print head.

In the trajectory generation method for the additive manufacturing provided by the disclosure, the step 103 of generating the sequence of filling paths for the filling lines of the cross-section of each of the layers specifically includes the following sub-step 103-1.

Sub-step 103-1, the sequence of filling paths for the filling lines of the cross-section of each of the layers is generated by using a zigzag topology.

In the embodiment, the sequence of filling paths is generated by the zigzag topology.

Specifically, two endpoints of an odd-numbered line of the filling paths are denoted as VStart[i] and VEnd[i], and the sequence of filling paths is generated in an order of i∈[1, 2, 3 . . . γ].

Two endpoints of an even-numbered line of the filling paths are denoted as VStart[i−1], VEnd[i−1], and the sequence of filling paths is generated in an order of i∈[γ . . . 3, 2, 1].

In the trajectory generation method for the additive manufacturing provided by the disclosure, the sub-step 102-2 of dividing the deviation angles based on the deviation angles and the preset path point numbers to obtain the angle division results of the deviation angles, specifically includes the following sub-step 102-2(1) through sub-step 102-2(3).

Sub-step 102-2(1), a first positioning point on each of the filling paths is determined, where a normal vector of the first positioning point is parallel to the Z-axis direction of the robot coordinate system and the first positioning point is closest to the start point of the filling path compared with other points on the filling path except the start point. A second positioning point on the filling path is determined, where a normal vector of the second positioning point is parallel to the Z-axis direction of the robot coordinate system and the second positioning point is closest to the end point of the filling path compared with other points on the filling path except the end point.

As illustrated in FIG. 5, for each of the filling paths, at the start area, the first positioning point on the filling path is determined, where the normal vector of the first positioning point is parallel to the Z-axis direction of the robot coordinate system and the first positioning point is closest to the start point of the filling path compared with other points on the filling path except the start point. At the end area, the second positioning point on the filling path is determined, where the normal vector of the second positioning point is parallel to the Z-axis direction of the robot coordinate system and the second positioning point is closest to the end point of the filling path compared with other points on the filling path except the end point. That is, in FIG. 5, an intersection point between a second dotted directional arrow from left to right and the filling path is the first positioning point, and an intersection point between a third dotted directional arrow from left to right and the filling path is the second positioning point.

Through the method described above, adjustment areas where the printing trajectory of the robot needs to be optimized are divided. It should be understood that the start area between the start point of the filling path and the first positioning point and the end area between the second positioning point and the end point of the filling path are areas where the printing trajectory of the robot needs to be adjusted and optimized due to a change in a printing angle of the robot. An area of the filling path between the first positioning point and the second positioning point is an area where the robot can complete printing by moving directly in an XOY plane.

Sub-step 102-2(2), a first included angle between the normal vector of the start point of the filling path and the normal vector of the first positioning point is evenly divided according to a preset path point number for the first included angle of the preset path point numbers. A second included angle between the normal vector of the end point of the filling path and the normal vector of the second positioning point is evenly divided according to a preset path point number for the second included angle of the preset path point numbers.

Sub-step 102-2(3), intersection points between angle bisectors evenly dividing the first included angle and the second included angle and the filling path are determined as the multiple path points.

As illustrated in FIG. 5, the first included angle is an included angle between first two dotted directional arrows from left to right, and the second included angle is an included angle between last two dotted directional arrows from left to right.

The first included angle is evenly divided according to the following angle equal division formula:

$$DIFS [ i ] = {\sum }_{1}^{t} ( mod ( AngZ [ i ] - AngS [ i ] + 180 , 360 ) - 180 ) / ( t + 1 ) ;$$

where, AngZ[i] represents the Z-axis direction of the robot coordinate system, AngS[i] represents the normal vector of the start point of the filling path, t represents the preset path point number for the first included angle, and mod ( ) represents a modulus function.

The second included angle is evenly divided according to the following angle equal division formula:

$$DIFE [ i ] = {\sum }_{1}^{t} ( mod ( AngE [ i ] - AngZ [ i ] + 180 , 360 ) - 180 ) / ( t + 1 ) ;$$

where, AngE[i] represents the normal vector of the end point of the filling path.

After dividing the first included angle and the second included angle, the multiple path points can be determined based on the intersection points between the angle bisectors obtained by dividing the first included angle and the second included angle, namely the dashed directional arrows in FIG. 5, and the filling path.

In the trajectory generation method for the additive manufacturing provided by the disclosure, before the sub-step 102-2 of dividing the deviation angles based on the deviation angles and the preset path point numbers, the trajectory generation method further includes sub-step 102-2 (a) through 102-2 (c).

Sub-step 102-2 (a), a first path length between the start point of the filling path and the first positioning point is determined; and a second path length between the end point of the filling path and the second positioning point is determined.

Sub-step 102-2 (b), the first path length and the second path length are determined as path lengths to be evenly divided.

Sub-step 102-2 (c), integers of ratios of the path lengths to be evenly divided to a melting speed of the robot are taken as the preset path point number for the first included angle and the preset path point number for the second included angle.

To more accurately determine the preset path point number for the first included angle and the preset path point number for the second included angle, as illustrated in FIG. 5, firstly, the path lengths L to be evenly divided corresponding to the start area and the end area of the filling path are determined.

Specifically, in each of the filling paths, a part between the start point of the filling path and the first positioning point is determined as a first path, and a length of the first path is determined as the first path length. A determination method for the second path length is the same as that for the first path length.

On this basis, the preset path point numbers are calculated according to the following formula:

$$t = L / V ;$$

where, V represents the melting speed of the robot, and V is generally in a range of 5 millimeters per second (mm/s) to 20 mm/s.

Since the preset path point numbers are integers, calculated results are rounded as the preset path point number for the first included angle and the preset path point number for the second included angle.

Optionally, the calculated results can be rounded through different rounding methods, such as rounding up or down to a nearest integer or setting a threshold to round.

In the embodiment, to ensure smooth movement of the robot, the preset path point number for the first included angle and the preset path point number for the second included angle are determined by rounding up to the nearest integer, thereby maximizing possible counts.

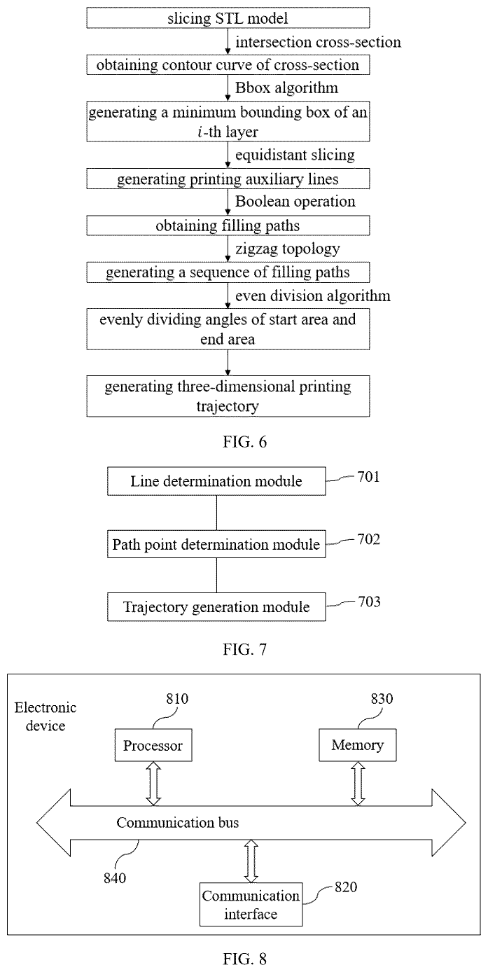

On this basis, a complete flowchart for the trajectory generation method is illustrated in FIG. 6.

The disclosure uses the minimum bounding box to evenly divide a contour of each of the layers of the to-be-printed model and then performs a Boolean operation on the contour of each of the layers and the set of printing auxiliary lines to generate the filling paths. At the same time, the disclosure optimizes the printing trajectory of the robot on each of the filling paths in the start area of the filling path between the start point and the first positioning point of the filling path and in the end area of the filling path between the second positioning point and the end point of the filling path according to a principle of angle equalization, making it easier to achieve support-free printing in a three-dimensional printing process, thereby further expanding practicality of a robotic arm printing system.

A trajectory generation device for the additive manufacturing provided by the disclosure is described below. The trajectory generation device for the additive manufacturing described below and the trajectory generation method for the additive manufacturing described above can correspond and refer to each other.

As illustrated in FIG. 7, the trajectory generation device for the additive manufacturing includes a line determination module 701, a path point determination module 702, and a trajectory generation module 703.

The line determination module 701 is configured to slice the to-be-printed model to obtain the layers of the to-be-printed model and determine the filling lines for the cross-section of each of the layers of the to-be-printed model.

Optionally, the to-be-printed model is sliced along the fixed direction, and the fixed direction can be determined according to the shape of the to-be-printed model, as long as the cross-section of each of the layers of the to-be-printed model can be easily printed after slicing the to-be-printed model.

Optionally, the to-be-printed model can be evenly sliced, or the to-be-printed model can be unevenly sliced according to the shape of the to-be-printed model.

After slicing the to-be-printed model, the shape of the cross-section of each of the layers of the to-be-printed model is determined, and then the filling lines for the cross-section of each of the layers is determined as a basis for filling paths based on the shape of the cross-section.

The path point determination module 702 is configured to determine the coordinates and directions of the multiple path points on each of the filling lines based on the angle division results between the normal vector of the start point of the filling line and the Z-axis direction of the robot coordinate system and between the normal vector of the end point of the filling line and the Z-axis direction of the robot coordinate system.

It should be noted that, during the additive manufacturing, when the robot prints the flat surface, the laser print head moves directly along the straight paths, so the printing speed of the robot is faster. However, when the robot prints the inclined or curved surfaces that are not perpendicular to the Z-axis direction of the robot coordinate system, the orientation of the laser print head must be adjusted to align with the normal vector of each path point to be printed. When the adjustment amplitude is large, the printing speed of the robot is slower.

For example, when the to-be-printed model is the sphere, after slicing the sphere along its radial direction, the outermost part of the cross-section of each of the layers is the curved surface, and the middle part of the cross-section is the flat part that can be directly printed. Therefore, during printing the outermost part and the middle part, it is prone to local deposition due to uneven printing speed.

Therefore, during the printing process, it is necessary to distinguish the flat part that can be directly printed from other parts that require rotation adjustment of the laser print head and optimize the rotation adjustment trajectory of the laser print head, so as to make the overall printing speed more balanced and reduce the occurrence of the phenomenon of local excessive deposition.

In the filling lines determined in the cross-section of the to-be-printed model, to determine the angle between the normal vector of the start point of the certain filling line and the Z-axis direction of the robot coordinate system and the angle between the normal vector of the end point of the certain filling line and the Z-axis direction of the robot coordinate system is to determine the areas in the certain filling line where the trajectory of the laser print head needs to be optimized.

To divide the angle between the normal vector of the start point of the certain filling line and the Z-axis direction of the robot coordinate system and the angle between the normal vector of the end point of the certain filling line and the Z-axis direction of the robot coordinate system is to divide the angle that needs to be adjusted when the laser print head moves once into multiple smaller angles, so as to facilitate the movement of the laser print head and improve the moving speed of the laser print head during printing the areas where the trajectory of the laser print head needs to be optimized.

On this basis, it should be understood that the optimization of the trajectory of the laser print head is carried out from the aspect of optimizing the rotational angle of the laser print head. The result of angle adjustment still needs to be converted into the printing trajectory, namely, the coordinates and directions of the multiple path points on the filling line, so as to finally determine the printing trajectory of the laser print head.

The trajectory generation module 703 is configured to determine the printing trajectory of the robot based on the coordinates and directions of the multiple path points.

The coordinates and directions of the multiple path points ultimately determined are organized into forms of the coordinates and normal vectors of the multiple path points. In the robot coordinate system, namely the working coordinate system of the laser print head, each of the multiple path points and the normal vector thereof are added to the controller of the robot in the forms of the three-dimensional coordinate position and the quaternion poses q1, q2, q3, and q4, thereby generating the three-dimensional printing trajectory of the laser print head, which is the printing trajectory of the robot.

The disclosure, through the optimization of the printing trajectory of the robot at the starting and ending positions of each of the layers to be printed of the to-be-printed model, the path point interpolation, and the posture optimization, makes the movement trajectory of the industrial robot smoother and the printing speed of the industrial robot uniform and avoids the phenomenon of excessive deposition in local areas.

FIG. 8 illustrates a schematic physical structural diagram of an electron device. As illustrated in FIG. 8, the electron device may include a processor 810, a communication interface 820, a memory 830, and a communication bus 840. The processor 810, the communication interface 820, and the memory 830 communicate with each other through the communication bus 840. The processor 810 can call logical instructions in the memory 830 to execute the trajectory generation method for the additive manufacturing, which includes: slicing the to-be-printed model to obtain the layers of the to-be-printed model, determining the filling lines for the cross-section of each of the layers of the to-be-printed model, determining the coordinates and directions of the multiple path points on each of the filling lines based on the angle division results between the normal vector of the start point of the filling line and the Z-axis direction of the robot coordinate system and between the normal vector of the end point of the filling line and the Z-axis direction of the robot coordinate system, and determining the printing trajectory of the robot based on the coordinates and directions of the multiple path points.

In addition, the logical instructions in the memory 830 described above can be implemented in a form of software functional units and can be stored in a computer-readable storage medium when sold or used as independent products. Based on this understanding, the technical solutions of the disclosure can be embodied in forms of a computer software product in essence or in parts that contribute to the related art. The computer software product is stored in a storage medium and includes several instructions to enable a computer device (including a personal computer, server, or network device, etc.) to perform all or part of the steps of the trajectory generation method described in various embodiments of the disclosure. The aforementioned storage media include various media that can store program code, including universal serial bus (USB) flash drives, portable hard drives, read-only memory (ROM), random access memory (RAM), magnetic disks, and optical disks.

In another aspect, the disclosure provides a computer program product. The computer program product includes a computer program. The computer program can be stored on a non-transitory computer-readable storage medium. When executed by a processor, the computer can implement the trajectory generation method for the additive manufacturing provided by the disclosure, which includes: slicing the to-be-printed model to obtain the layers of the to-be-printed model, determining the filling lines for the cross-section of each of the layers of the to-be-printed model, determining the coordinates and directions of the multiple path points on each of the filling lines based on the angle division results between the normal vector of the start point of the filling line and the Z-axis direction of the robot coordinate system and between the normal vector of the end point of the filling line and the Z-axis direction of the robot coordinate system, and determining the printing trajectory of the robot based on the coordinates and directions of the multiple path points.

In yet another aspect, the disclosure provides a non-transitory computer-readable storage medium storing a computer program. The computer program is executed by a processor to implement the trajectory generation method for the additive manufacturing, which includes: slicing the to-be-printed model to obtain the layers of the to-be-printed model, determining the filling lines for the cross-section of each of the layers of the to-be-printed model, determining the coordinates and directions of the multiple path points on each of the filling lines based on the angle division results between the normal vector of the start point of the filling line and the Z-axis direction of the robot coordinate system and between the normal vector of the end point of the filling line and the Z-axis direction of the robot coordinate system, and determining the printing trajectory of the robot based on the coordinates and directions of the multiple path points.

Embodiments of the device described above are only illustrative, and units described as separate components may or may not be physically separated, and components displayed as units may or may not be physical units; that is, they can be located in one place or distributed across multiple network units. Some or all of modules can be selected according to actual needs to achieve objectives of the embodiments of the disclosure. Those skilled in the art can understand and implement the embodiments of the disclosure without creative labor.

Through description of the aforementioned embodiments, those skilled in the art can clearly understand that each embodiment can be implemented through software and necessary general hardware platforms, and, of course, can also be implemented through hardware. Based on this understanding, the technical solutions of the disclosure can be embodied in the forms of the computer software product in essence or in parts that contribute to the related art. The computer software product can be stored in computer-readable storage media such as ROM/RAM, magnetic disks, optical disks, etc. The computer software product includes several instructions to enable the computer device (including the personal computer, the server, the network device, etc.) to implement the methods described in various embodiments or parts of the embodiments.

Finally, it should be noted that the aforementioned embodiments are only used to illustrate the technical solutions of the disclosure, rather than limit the disclosure. Although the disclosure has been described in detail with reference to the aforementioned embodiments, those skilled in the art should understand that they can still modify the technical solutions described in the aforementioned embodiments or equivalently replace some of the technical features in the technical solutions; and these modifications or replacements do not make essence of corresponding technical solutions depart from a spirit and scope of the embodiments of the disclosure.

What is claimed is:

1. A trajectory generation method for additive manufacturing, comprising the following steps:
slicing a to-be-printed model to obtain layers of the to-be-printed model, and determining filling lines for a cross-section of each of the layers of the to-be-printed model;
determining coordinates and directions of a plurality of path points on each of the filling lines based on angle division results between a normal vector of a start point of the filling line and a Z-axis direction of a robot coordinate system and between a normal vector of an end point of the filling line and the Z-axis direction of the robot coordinate system; and
determining a printing trajectory of a robot based on the coordinates and directions of the plurality of path points;
wherein the slicing a to-be-printed model to obtain layers of the to-be-printed model, and determining filling lines for a cross-section of each of the layers of the to-be-printed model specifically comprises the following steps:
slicing the to-be-printed model along the Z-axis direction of the robot coordinate system, and determining a contour curve of the cross-section of each of the layers obtained by slicing;
determining a minimum bounding box of the contour curve of the cross-section of each of the layers, and generating a set of printing auxiliary lines for the minimum bounding box based on a predetermined offset distance; and
performing intersection Boolean operation between the contour curve of the cross-section of each of the layers and the set of printing auxiliary lines to obtain the filling lines for the cross-section of each of the layers.

2. The trajectory generation method for the additive manufacturing as claimed in claim 1, wherein the determining coordinates and directions of a plurality of path points on each of the filling lines based on angle division results between a normal vector of a start point of the filling line and a Z-axis direction of a robot coordinate system and between a normal vector of an end point of the filling line and the Z-axis direction of the robot coordinate system specifically comprises the following steps:
generating a sequence of filling paths for the filling lines of the cross-section of each of the layers, and determining a normal vector of a start point of each of filling paths in the sequence of filling paths and a normal vector of an end point of each of the filling paths in the sequence of filling paths;
determining deviation angles between the normal vector of the start point of each of the filling paths in the sequence of filling paths and the Z-axis direction of the robot coordinate system and between the normal vector of the end point of each of the filling paths in the sequence of filling paths and the Z-axis direction of the robot coordinate system, and dividing the deviation angles based on the deviation angles and preset path point numbers to obtain the angle division results of the deviation angles; and
determining the coordinates and directions of the plurality of path points based on the angle division results of the deviation angles.

3. The trajectory generation method for the additive manufacturing as claimed in claim 2, wherein the generating a sequence of filling paths for the filling lines of the cross-section of each of the layers specifically comprises:
generating the sequence of filling paths for the filling lines of the cross-section of each of the layers by using a zigzag topology.

4. The trajectory generation method for the additive manufacturing as claimed in claim 2, wherein the dividing the deviation angles based on the deviation angles and preset path point numbers to obtain the angle division results of the deviation angles, specifically comprises:
determining a first positioning point on each of the filling paths, where a normal vector of the first positioning point is perpendicular to the Z-axis direction of the robot coordinate system and the first positioning point is closest to the start point of the filling path compared with other points on the filling path except the start point; and determining a second positioning point on the filling path, where a normal vector of the second positioning point is perpendicular to the Z-axis direction of the robot coordinate system and the second positioning point is closest to the end point of the filling path compared with other points on the filling path except the end point;
evenly dividing a first included angle between the start point of the filling path and the normal vector of the first positioning point according to a preset path point number for the first included angle of the preset path point numbers; and evenly dividing a second included angle between the end point of the filling path and the normal vector of the second positioning point according to a preset path point number for the second included angle of the preset path point numbers; and
determining intersection points between angle bisectors evenly dividing the first included angle and the second included angle and the filling path as the plurality of the path points.

5. The trajectory generation method for the additive manufacturing as claimed in claim 4, before dividing the deviation angles based on the deviation angles and the preset path point numbers, further comprising:
determining a first path length between the start point of the filling path and the first positioning point; and determining a second path length between the end point of the filling path and the second positioning point;
determining the first path length and the second path length as path lengths to be evenly divided; and
taking integers of ratios of the path lengths to be evenly divided to a melting speed of the robot as the preset path point number for the first included angle and the preset path point number for the second included angle.

6. A trajectory generation device for additive manufacturing, comprising:
a line determination module, configured to slice a to-be-printed model to obtain layers of the to-be-printed model, and determine filling lines for a cross-section of each of the layers of the to-be-printed model;
a path point determination module, configured to determine coordinates and directions of a plurality of path points on each of the filling lines based on angle division results between a normal vector of a start point of the filling line and a Z-axis direction of a robot coordinate system and between a normal vector of an end point of the filling line and the Z-axis direction of the robot coordinate system; and
a trajectory generation module, configured to determine a printing trajectory of a robot based on the coordinates and directions of the plurality of path points;
wherein the line determination module is further configured to:
slice the to-be-printed model along the Z-axis direction of the robot coordinate system, and determine a contour curve of the cross-section of each of the layers obtained by slicing;
determine a minimum bounding box of the contour curve of the cross-section of each of the layers, and generate a set of printing auxiliary lines for the minimum bounding box based on a predetermined offset distance; and
perform intersection Boolean operation between the contour curve of the cross-section of each of the layers and the set of printing auxiliary lines to obtain the filling lines for the cross-section of each of the layers.

7. An electronic device, comprising a memory, a processor, and a computer program stored on the memory and executable on the processor, wherein the processor is configured to execute the computer program to implement the trajectory generation method for the additive manufacturing as claimed in claim 1.

8. A non-transitory computer-readable storage medium, wherein a computer program is stored in the non-transitory computer-readable storage medium, and the computer program is configured to, when executed by a processor, implement the trajectory generation method for the additive manufacturing as claimed in claim 1.

9. A computer program product, comprising a computer program, wherein the computer program is configured to, when executed by a processor, implement the trajectory generation method for the additive manufacturing as claimed in claim 1.
